(19) United States
(12) Patent Application Publication
(10) Pub. No.: US 2009/0308174 A1
(43) Pub. Date: Dec. 17, 2009

(54) TORSION TOOL TESTER

(75) Inventor: Mark L. Cutshall, Livonia, MI (US)

Correspondence Address: BROOKS KUSHMAN P.C., 1000 TOWN CENTER, TWENTY-SECOND FLOOR, SOUTHFIELD, MI, 48075, US

(73) Assignee: E & E MANUFACTURING COMPANY, INC., Plymouth, MI (US)

(21) Appl. No.: 12/140,458

(22) Filed: Jun. 17, 2008

(51) Int. Cl. G01N 3/22

(52) U.S. Cl. 73/847

(57) ABSTRACT

A torsion tool testing fixture is disclosed. It comprises a ring with locking teeth engageable with a test feature and a housing surrounding the locking teeth. A securement for the test feature is tested for quality by applying a predetermined limiting torque to the housing.

### BACKGROUND OF THE INVENTION

1. Field of the Invention

The invention relates to a torsion tool test fixture or test head for use in determining the quality of a securement of a feature to a planar surface.

2. Background Art

In manufacturing operations involving metal welding, it is known design practice to secure features, such as a weld nut, to a surface of a metal plate. A weld nut may be secured to a metal plate, for example, using a projection welding technique in which welding projections on a weld nut form weld metal zones. A welding electrode creates a welding force on the weld nut as high voltage welding current is applied during a weld cycle of predetermined duration. In order to test weld integrity or quality, an impact tool in a destructive test is used to break the weld so that the quality of the weld zone for the projections can be examined. In a high volume manufacturing procedure, multiple weld nuts may be secured to a given surface. A weld testing operation can be carried out on a selected test weld in a group of welds so that weld quality of each weld nut in the group can be inferred by observing the quality of the test weld during the destructive test of the selected test weld nut. If the examined test weld meets quality standards, the welding pressure and current for the test weld cycle may be repeated for subsequent welds.

It is known design practice also to use a torque limiting tool in a non-destructive torque test of a welded nut whereby a predetermined torque is applied to the nut. If the weld is of sufficient quality to avoid failure as the limited torque is applied, the test then will have demonstrated that the weld quality will meet preestablished standards for a given application. A non-destructive testing procedure of this type requires a special test tool that is adapted to accommodate a given test piece. A test tool design typically is usable only with a given test piece design or shape. This has the disadvantage of requiring multiple special test tools for testing features of various shapes. Further, increased man-hours for final inspection in high volume manufacturing operations are required because of a need for frequent test tool changes, which compromise efficiency.

### SUMMARY OF THE INVENTION

The invention comprises a tool fixture for use in an efficient non-destructive test of a welded feature, such as a weld nut attached to a metal surface. Although the embodiment of the disclosed invention is especially adapted for use in testing weld nuts, it may be used as well for testing features that are fastened by other securements.

According to the embodiment of the disclosed invention, a weld nut feature that is secured to a metal plate by welding can be tested to determine whether it has sufficient weld metal penetration. The test may be executed using a common air pressure powered torsion drill. The tool test fixture of the invention is designed to permit the weld nut feature to slide into the test fixture as the fixture is turned in one direction. Spring loaded teeth carried by an internal cam ring then firmly grip the feature. The test fixture can accommodate a common torsion drill or an air-powered torque wrench for applying a torque in the opposite direction. It can be used, for example, with an octagonal weld nut, or with a feature with any other shape, such as a round bushing that is welded to a metal plate. The feature may be secured to a metal surface by projection welding or by other fastening techniques, such as continuous bead welding or by tack welding.

The test fixture of the invention includes a housing or body with an internal adjustable ring or actuating cam. Internal locking teeth are pivotally secured to the ring. A torsion spring between the ring and the housing urges the ring toward a position that allows the teeth to grip the feature.

As the test fixture is turned by applying a torque on the housing in one direction, the teeth will pivot in a direction that will permit the feature to slide into the ring. As this is done, the torsion spring is loaded so that when torque on the housing is released, the tension on the spring will hold the teeth firmly against the feature. Torque then is applied in the opposite direction to the feature using a torque limiting tool, such as a torque wrench, of known design. The housing, with the internal ring and locking teeth assembled inside, is closed by a cover plate.

Since the torsion tool fixture of the present invention permits the use of a non-destructive test, each weld of a multiple weld nut assembly, for example, may readily be tested for proper weld metal penetration. Proper weld metal penetration need not be merely inferred.

### BRIEF DESCRIPTION OF THE DRAWINGS

FIG. 1 is a perspective overall view of the exterior of a housing or body for the tool fixture of the invention;

FIG. 2 is a view of the base of the fixture shown in FIG. 1, together with locking teeth that are positioned to accommodate entry of a welded feature within the tester;

FIG. 3 is a view similar to FIG. 2, although the locking teeth are rotated inwardly;

FIG. 4 is a view of the internal ring or cam located in the housing shown in FIG. 1 with the housing and cover plate removed;

FIG. 5 is an assembly view, with the housing removed, of a cover plate for the housing of FIG. 1 and the internal ring of FIG. 4 together with a torsion spring for applying a gripping force on the teeth;

FIG. 6 is a view similar to FIG. 4 showing the internal ring positioned in the housing;

FIG. 7 is a view similar to FIG. 6 wherein an octagonal nut is inserted within the internal ring;

FIG. 8 is a view similar to FIG. 7, although it shows a round test piece inserted in the internal ring rather than the octagonal nut shown in FIG. 7; and

FIG. 9 is a view of an internal ring or cam mounted within the housing and a torsion spring with end tangs anchored in the housing and the internal ring.

### PARTICULAR DESCRIPTION OF AN EMBODIMENT OF THE INVENTION

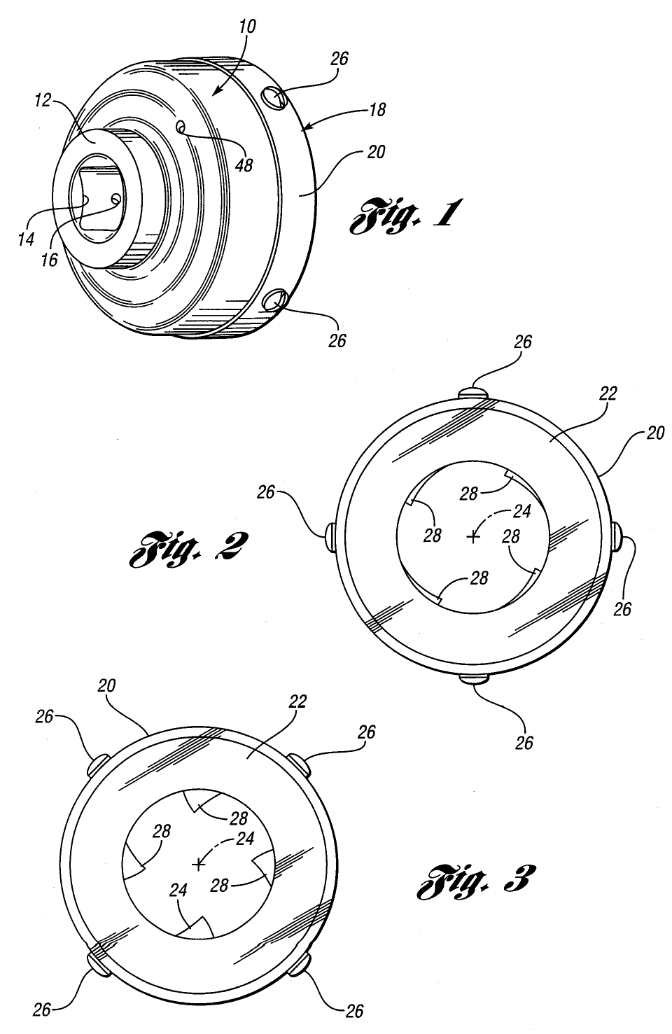

Numeral 10 in FIG. 1 shows the housing for a torsion tool fixture that embodies the invention. It comprises a circular body having an adapter in the form of a collar 12 on the left side of the body, as viewed in FIG. 1. An opening 14 has a cross section that, for example, may be square, hexagonal, or multi-faceted. The opening 14 in collar 12 is adapted to accommodate a conventional torque wrench drive shaft. A spring loaded ball detent shown at 16 may be included to maintain the torque wrench drive shaft in place once it is secured within the opening 14.

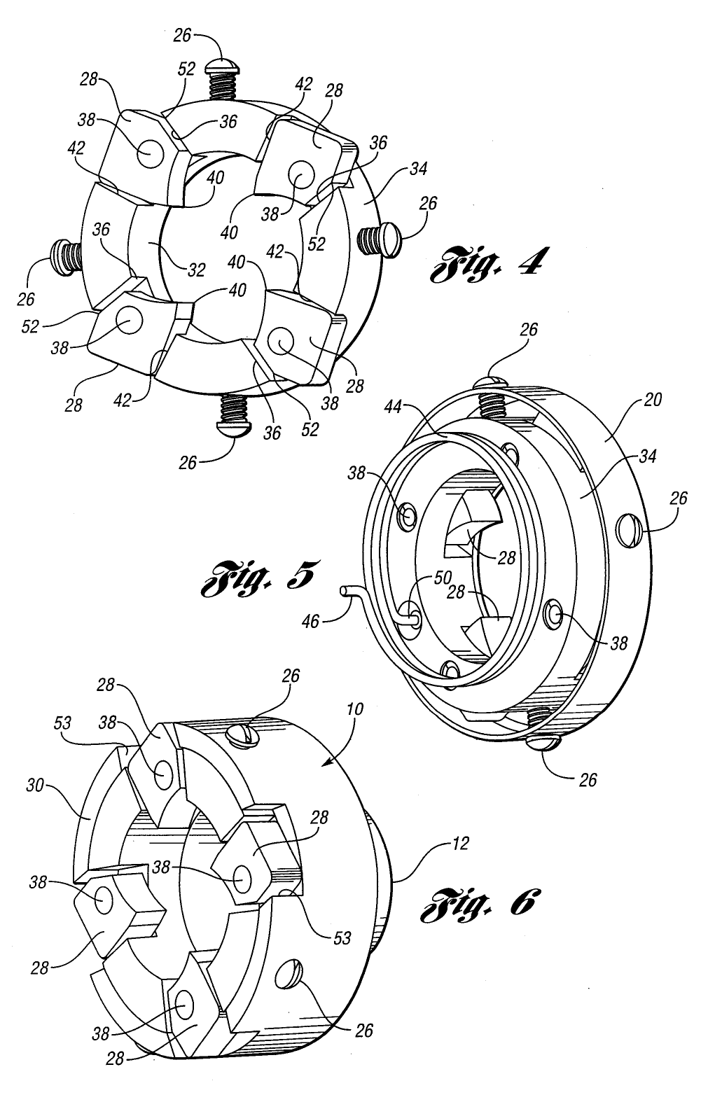

The side of the housing 10 opposite to the opening 14 is surrounded by a housing cover plate 18 having a peripheral portion 20. The cover plate includes a radial portion 22, as seen in FIG. 2, which extends radially inward toward the axis of the housing indicated at 24. Set screws 26 are threadably received in the housing and the portion 20 to secure the plate 22 to the housing. An internal ring or cam 34, seen in FIGS. 4-6, rotatably supports a plurality of locking teeth 28, which can be pivoted radially outward, as viewed in FIG. 2, or radially inward, as viewed in FIG. 3, with respect to axis 24. FIGS. 2 and 3 are similar, although the locking teeth 28 are adjusted radially inward in the case of FIG. 3 and radially outward as in the case of FIG. 2. The internal ring 34 is supported by the housing 10 for relative angular adjustment.

The interior ring or cam 34 within the housing 10 comprises a cylindrical body with a central opening 32 and an outer periphery 34. The periphery 34 is received within the peripheral portion 30 of the housing 10, but seen in FIGS. 6 and 9.

The ring 34 has recesses, as shown at 36, each recess receiving a locking tooth 28. Each locking tooth 28 is pivotally supported in their respective recesses 36 by a pivot pin 38. Each locking tooth has a tooth edge 40, which is adjustable toward the axis 24 when a locking tooth is rotated in a counter-clockwise direction as viewed in FIG. 4. The counter-clockwise pivoting motion of the tooth causes an edge 42 of the tooth to engage one side 42 of its respective recesses 36.

FIG. 5 shows the ring 34 with the housing removed for clarity. A helical torsion spring 44 is positioned within the housing 10 adjacent the ring 34. One end tang 46 of the spring 44 is anchored in an opening in the housing 10, as seen at 48 in FIG. 1. The other end tang 50 of the spring 44 is anchored in an opening in the ring 34, as seen in FIG. 5. When the locking teeth 28 are positioned, as shown in FIG. 5, the torsion spring is relaxed and unloaded. When the locking teeth 28 are pivoted in the clockwise direction, as seen in FIG. 4, an edge 52 of each locking tooth is positioned to be engaged by an adjacent edge of a recess 3 6 formed in housing 10 which torsionally loads spring 44.

When the fixture is placed over a test feature, the feature engages the lower surface of each tooth. As the fixture is turned in a clockwise direction as seen in FIG. 6, the teeth will pivot toward the positions shown in FIG. 2 due to a friction torque at the interface of teeth and the test feature. That permits the tooth edge 40 of each tooth to engage a side of the feature.

Housing 10 has peripheral recesses 53, best seen in FIGS. 6 and 9. Teeth 28 extend radially outward through recesses 36 as seen in FIG. 6. When the fixture is turned in a counter-clockwise direction as viewed in FIG. 6, the teeth edges 40 will be locked to the feature as an edge of recesses 53 engage radially outward edges of teeth 28. Torque thus is transmitted to the feature.

FIG. 6 is a view similar to FIG. 5, although FIG. 6, for purposes of clarity, does not include the torsion spring.

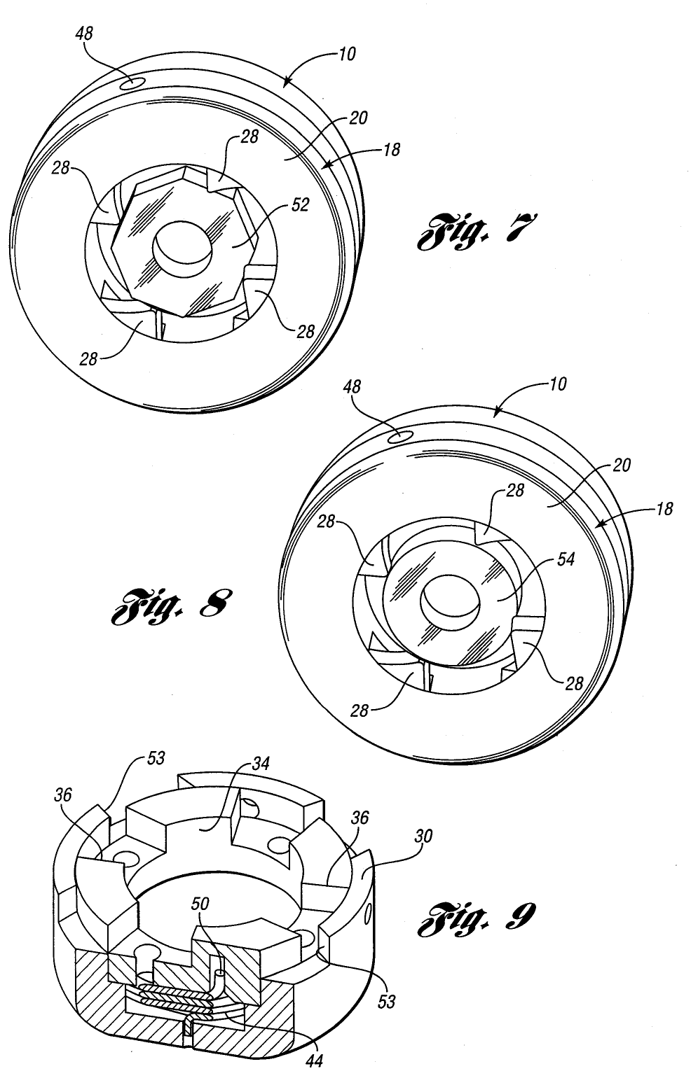

FIG. 7 is a view that shows the structure illustrated in FIG. 3, although the view of FIG. 7 is from a different perspective relative to the view of FIG. 3. FIG. 7 furthermore shows an octagonal nut 52, which is received within the housing ring 18. The nut, as seen in FIG. 7, is engaged by the teeth 28 which are held securely in place under the load of the torsion spring 44. The teeth 28 are rotated toward the position shown in FIG. 2 to permit entry of the weld nut 52 within the housing ring 18. As the teeth rotate, the ring 30 shifts rotatably relative to the housing 10, which loads the spring as previously mentioned.

FIG. 8 shows a round test feature at 54 which can be tested in the same fashion as a test of the octagonal nut 52. The feature 54 may, for example, be a bushing or a round washer.

In carrying out the testing operation for features such as those illustrated in FIGS. 7 and 8, which may be projection welded to a metal surface, the fixture is placed over the feature so that the feature enters the housing ring 20. The feature may slide into the housing ring 20 by rotating the housing 10 in a counter-clockwise direction relative to the position shown in FIG. 1. The welded feature will engage the teeth at this time. The counter-clockwise rotation of the housing will cause the teeth to rotate toward the position shown in FIG. 2 because of the torsional friction between the feature and the sides of the teeth. The teeth thus are pivoted until the feature will slide in place. This will cause tension to occur on the spring so that when a manual force in a counter-clockwise direction is relieved, the teeth will be held firmly against the feature. Then by turning the fixture tool in a clockwise direction, the teeth will tighten down on the feature when the torque wrench applies torque to the housing. As previously mentioned, the torque wrench would include a drive shaft or other driven element that would be received in the opening 14. If the weld on the feature is not broken as a predetermined torque is applied, the weld will have successfully passed the integrity or quality test.

Although the present embodiment of the invention is intended for use with weld nuts or other features such as a round bushing, it may be test for other types of features. The same torsion tool may be used for a variety of test feature pieces without changing work station tooling in a manufacturing assembly facility.

Although an embodiment of the invention has been disclosed, modifications may be made without departing from the scope of the invention. All such modifications and improvements thereof are intended to be covered by the following claims.

What is claimed is:

1. A torsion tool test fixture for use with a torque limiting torsion tool, the test fixture comprising:
a fixture housing with a central axis;
a torsion tool adapter located on the fixture housing at the central axis;
a fixture ring located in the fixture housing, the ring and the fixture housing being disposed concentrically with respect to the central axis; and
a plurality of locking teeth pivotally carried by the ring, the teeth being engageable with the fixture housing;
the teeth being adapted to engage a test feature secured to a surface whereby torque applied to the tool adapter by the torsion tool is transmitted to the feature during a torsion test of a securement of the feature to the surface.

2. A torsion tool test fixture for use with a torque limiting torsion tool for applying torque to a test feature, the test fixture comprising:
a fixture housing with a central axis;
a torsion tool adapter located on the fixture housing at the central axis;
a fixture ring located in the fixture and supported for rotary motion about the control axis with respect to the fixture housing;
the fixture ring and the fixture housing being disposed concentrically with respect to the central axis;
a plurality of locking teeth pivotally carried by the ring, the teeth being engageable with the fixture housing;
a torsion spring in the housing for applying a spring force on the ring that urges the ring in one direction to lock the ring to the test feature;
recesses in a periphery of the fixture housing, the locking teeth being disposed in the recesses, whereby the housing engages the teeth as torque is applied to the housing by the torsion tool.

3. The tension tool test fixture set forth in claim 1 wherein the ring is rotatably movable relative to the housing about the central axis and is restrained against lateral movement relative to the housing.

4. The tension tool test fixture set forth in claim 2 wherein the ring is rotatably movable relative to the housing about the central axis and is restrained against lateral movement relative to the housing.

5. The tension tool test fixture set forth in claim 4 wherein the locking teeth are formed with abutment surfaces, the recesses in the periphery of the fixture housing engaging the abutment surfaces on the locking teeth as torque is applied to the torsion tool adapter.

6. The tension tool tester set forth in claim 2 wherein the fixture ring is supported concentrically within the fixture housing to accommodate rotary movement of the fixture ring relative to the fixture housing.
